(19) United States
(12) Patent Application Publication
(10) Pub. No.: US 2026/0070154 A1
(43) Pub. Date: Mar. 12, 2026

(54) JOINING METHOD OF DISSIMILAR MATERIALS

(71) Applicant: KABUSHIKI KAISHA TOSHIBA, Tokyo (JP)

(72) Inventors: Go OBARA, Setagaya (JP); Takashi OBARA, Yokohama (JP); Yuta NAKAMOTO, Yokohama (JP)

(73) Assignee: KABUSHIKI KAISHA TOSHIBA, Tokyo (JP)

(21) Appl. No.: 19/268,010

(22) Filed: Jul. 14, 2025

(30) Foreign Application Priority Data
Sep. 9, 2024 (JP) 2024-155081

(51) Int. Cl. B23K 26/324; B23K 26/352; B23K 103/00; B23K 103/18; B29C 65/00

(52) U.S. Cl. CPC B23K 26/324; B23K 26/352; B29C 66/742; B23K 2103/18; B23K 2103/42

(57) ABSTRACT

A joining method of dissimilar materials, the dissimilar materials being a joining member and a joined member, the method including: performing surface treatment of a joining surface of the joining member; overlaying the joining member and the joined member; heating the joined member by irradiating a laser on a surface of the joining member at a side opposite to the joining surface, the laser being irradiated at an irradiation condition that forms a keyhole; and joining the joining member and the joined member.

### CROSS-REFERENCE TO RELATED APPLICATIONS

This application is based upon and claims the benefit of priority from Japanese Patent Application No. 2024-155081, filed on Sep. 9, 2024; the entire contents of which are incorporated herein by reference.

### FIELD

Embodiments described herein relate generally to a joining method of dissimilar materials.

### BACKGROUND

Friction lap welding and the like are known as joining methods of dissimilar materials.

There is room for improvement in the method according to 5817140 JP B in that it is necessary to coat a chemical on a joining member and apply a weight to the joining member and a joined member, which make the method labor intensive and cause deformation of the members.

### BRIEF DESCRIPTION OF THE DRAWINGS

FIG. 1 is a flowchart for describing a procedure of a joining method according to the embodiment;

FIG. 2 is a schematic cross-sectional view for describing the surface treatment process of the joining member (S100);

FIG. 3 is a schematic cross-sectional view for describing the overlaying process (S200) of the joining surfaces;

FIG. 4 is a schematic cross-sectional view for describing the laser irradiation process (S300);

FIG. 5 is an enlarged schematic cross-sectional view of the joining surfaces in the laser irradiation process (S300); and

FIG. 6 is a schematic cross-sectional view for describing the joining process (S400) of the joining surface.

### DETAILED DESCRIPTION

A joining method according to an embodiment is a joining method of dissimilar materials; and the dissimilar materials are a joining member and a joined member. The joining method includes a surface treatment process of the joining member, an overlaying process of joining surfaces, a laser irradiation process, and a joining process of the joining surfaces. The surface treatment process of the joining member includes performing surface treatment on the joining surface of the joining member. The overlaying process of the joining surfaces includes overlaying the joining member and the joined member. The laser irradiation process includes heating the joined member by irradiating a laser on a surface of the joining member at a side opposite to the joining surface at an irradiation condition that forms a keyhole. The joining process of the joining surface includes joining the joining member and the joined member.

### Embodiments

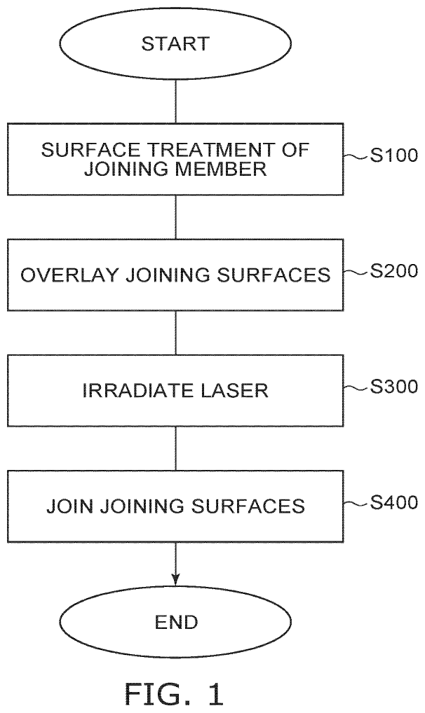

An embodiment will now be described. FIG. 1 is a flowchart for describing a procedure of a joining method according to the embodiment. As shown in FIG. 1, the joining method of the disclosure is performed in the order of a surface treatment process (S100) of a joining member, an overlaying process (S200) of joining surfaces, a laser irradiation process (S300), and a joining process (S400) of the joining surfaces. The processes will now be described in detail.

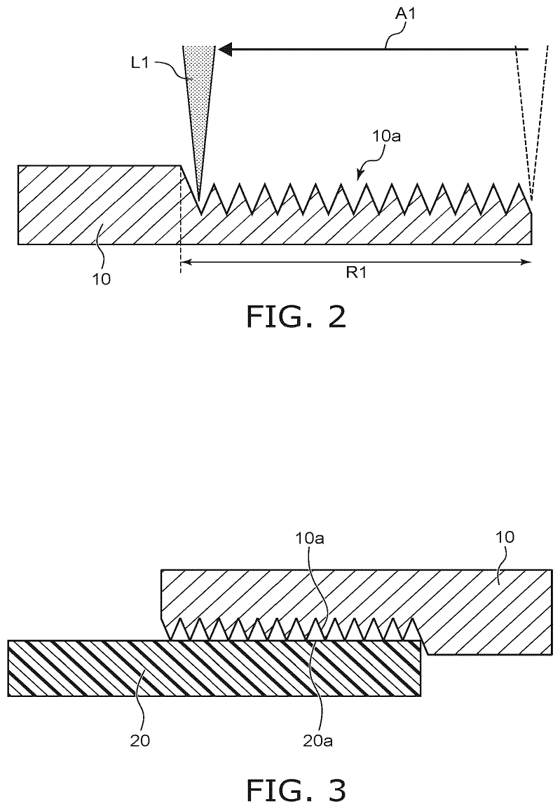

FIG. 2 is a schematic cross-sectional view for describing the surface treatment process of the joining member (S100).

The surface treatment process (S100) of the joining member includes performing surface treatment of a joining surface 10a of a joining member 10. As an example according to the embodiment, the joining member 10 is a metal; and specific examples of the joining member 10 include aluminum, copper, iron, stainless steel, etc. As the surface treatment, cleaning treatment is performed in which laser patterning is performed by irradiating a laser L1 on the joining member 10. Specifically, the laser L1 is irradiated while moving in the direction of arrow A1 over the entire joining region R1 of the joining member 10 that will be joined with a joined member 20 (see FIG. 3). As a result, an unevenness is formed over the entire joining surface 10a in the joining region R1; and the joining can be made secure by an anchor effect and/or chemical bonds. The irradiation conditions of the laser L1 in the surface treatment may have a power density of not less than 50 J/cm² and not more than 200 J/cm². The width of the unevenness may be 5 μm to 100 μm.

FIG. 3 is a schematic cross-sectional view for describing the overlaying process (S200) of the joining surfaces.

The overlaying process (S200) of the joining surfaces includes overlaying the joining surface 10a of the joining member 10 and a joining surface 20a of the joined member 20. The joined member 20 has a lower melting point than the joining member 10; as an example, the joined member 20 is a resin; and specific examples of the joined member 20 include CFRP (Carbon-Fiber-Reinforced Plastic), PEEK (PolyEtherEtherKetone), etc.

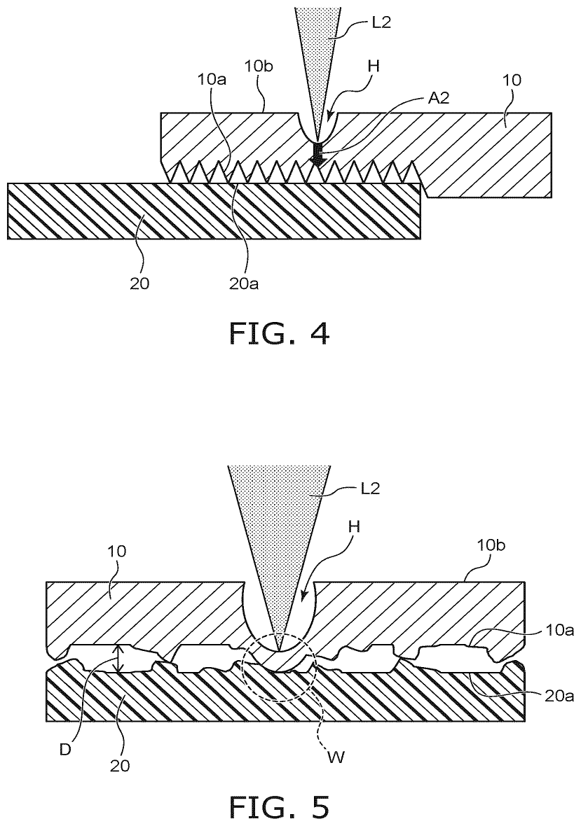

FIG. 4 is a schematic cross-sectional view for describing the laser irradiation process (S300).

The laser irradiation process (S300) includes irradiating a laser L2 on an irradiation surface 10b of the joining member 10 at the side opposite to the joining surface 10a so that a keyhole H is formed in the joining member 10. The conditions for forming the keyhole H may include, for example, a power density of not less than 106 W/cm². By irradiating the laser L2 at such a condition, a portion of the joining member 10 is melted from the irradiation surface 10b side; and the keyhole H is formed in the direction of arrow A2 from the irradiation surface 10b.

FIG. 5 is an enlarged schematic cross-sectional view of the joining surfaces in the laser irradiation process (S300).

The enlarged illustration of FIG. 5 shows that fine gaps D are formed between the joining surface 10a of the joining member 10 and the joining surface 20a of the joined member 20. According to the embodiment, by irradiating the laser L2 so that the keyhole is formed in the joining member 10, a penetration bead W (a protrusion formed at the surface at side opposite to the irradiation surface of the laser) is formed at the joining surface 10a of the joining member 10; and the joined member 20 is heated. The joined member 20 has a lower melting point than the joining member 10 and is melted by the irradiation of the laser L2.

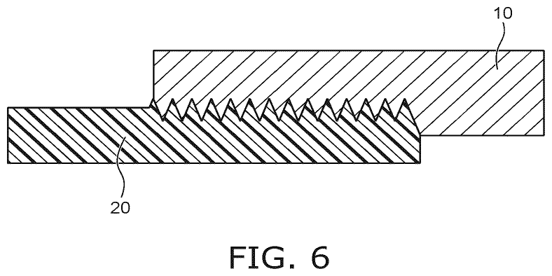

FIG. 6 is a schematic cross-sectional view for describing the joining process (S400) of the joining surface.

In the joining process (S400) of the joining surfaces, the heat of the joining member 10 heated and melted by the irradiation of the laser L2 is conducted to the joined member 20; and the joined member 20 is heated and melted. As a result, the joining surface 10a of the joining member 10 and the joining surface 20a of the joined member 20 are joined.

### SUMMARY

According to the embodiments above, the joining method of the disclosure is a joining method of dissimilar materials; the dissimilar materials are the joining member 10 and the joined member 20; and the joining method includes a process of performing surface treatment on the joining surface 10a of the joining member 10, a process of overlaying the joining member 10 and the joined member 20, a process of heating the joined member 20 by irradiating a laser on the irradiation surface 10b of the joining member 10 at the side opposite to the joining surface 10a at an irradiation condition that forms a keyhole, and a process of joining the joining member 10 and the joined member 20. By using such a configuration, the joining member 10 and the joined member 20 can be joined by a simple method without applying a weight to the joining member 10 and the joined member 20, without using a chemical or the like for joining, and without deforming the members.

The process of performing the surface treatment includes performing cleaning treatment of the joining surface 10a. As a result, organic substances such as carbon and the like adhered to the joining surface 10a can be removed, and the joining surface 10a can be activated.

The cleaning treatment includes forming an unevenness in the joining surface by laser patterning. As a result, the joining member 10 and the joined member 20 can be securely joined due to the anchor effect caused by the unevenness of the joining surface.

The joined member 20 has a lower melting point than the joining member 10; and the heating process includes heating the joined member 20 to not less than the melting point and not more than the boiling point. As a result, the joined member 20 can be melted by laser irradiation on the joining member 10; and the joining member 10 and the joined member 20 can be joined.

The joining member may be a metal; and the joined member may be a resin. By using such a configuration, the technical idea of the disclosure is concretely applicable to obtain the effects described above when joining dissimilar materials to each other.

### Other Embodiments

Although embodiments of the disclosure are described above, the embodiments are not limited thereto. For example, although unevenness formation by laser patterning is performed as the surface treatment of the joining surface 10a of the joining member 10 in S100 according to the embodiments above, the surface treatment is not limited to such an embodiment. For example, plasma processing of the joining surface 10a of the joining member 10 may be performed as the surface treatment. Also, surface treatment other than cleaning treatment may be performed.

While certain embodiments of the inventions have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments herein may be made without departing from the spirit of the inventions. The accompanying claims and their equivalents are intended to cover such forms or modifications as would fall within the scope and spirit of the inventions.

The inventions include the following aspects.

### Appendix 1

A joining method of dissimilar materials, the dissimilar materials being a joining member and a joined member, the method comprising:
performing surface treatment of a joining surface of the joining member;
overlaying the joining member and the joined member;
heating the joined member by irradiating a laser on a surface of the joining member at a side opposite to the joining surface, the laser being irradiated at an irradiation condition that forms a keyhole; and
joining the joining member and the joined member.

### Appendix 2

The method according to appendix 1, wherein
the surface treatment includes performing cleaning treatment of the joining surface.

### Appendix 3

The method according to appendix 2, wherein
the cleaning treatment includes forming an unevenness in the joining surface by laser patterning.

### Appendix 4

The method according to appendix 3, wherein
the cleaning treatment includes forming an unevenness in an entirety of the joining surface by the laser patterning.

### Appendix 5

The method according to appendix 1, wherein
the joined member has a lower melting point than the joining member, and the heating includes heating the joined member to not less than the melting point of the joined member and not more than a boiling point of the joined member.

### Appendix 6

The method according to appendix 5, wherein
the joining member is a metal, and
the joined member is a resin.

What is claimed is:

1. A joining method of dissimilar materials, the dissimilar materials being a joining member and a joined member, the method comprising:
performing surface treatment of a joining surface of the joining member;
overlaying the joining member and the joined member;
heating the joined member by irradiating a laser on a surface of the joining member at a side opposite to the joining surface, the laser being irradiated at an irradiation condition that forms a keyhole; and
joining the joining member and the joined member.

2. The method according to claim 1, wherein
the surface treatment includes performing cleaning treatment of the joining surface.

3. The method according to claim 2, wherein
the cleaning treatment includes forming an unevenness in the joining surface by laser patterning.

4. The method according to claim 3, wherein
the cleaning treatment includes forming an unevenness in an entirety of the joining surface by the laser patterning.

5. The method according to claim 1, wherein
the joined member has a lower melting point than the joining member, and
the heating includes heating the joined member to not less than the melting point of the joined member and not more than a boiling point of the joined member.

6. The method according to claim 5, wherein
the joining member is a metal, and
the joined member is a resin.
